(19) United States
(12) Patent Application Publication
(10) Pub. No.: US 2022/0313534 A1
(43) Pub. Date: Oct. 6, 2022

(54) TWO STAGE ACTUATOR FOR POWERED MOBILITITY ASSISTANCE DEVICES WITH ELECTRICAL ISOLATION

(71) Applicant: Parker-Hannifin Corporation, Cleveland, OH (US)

(72) Inventors: Ryan J. FARRIS, Dillsburg, PA (US); Steven ETHERIDGE, Aurora, OH (US); Scott A. MORRISON, Mount Pleasant, MI (US)

(21) Appl. No.: 17/625,168

(22) PCT Filed: Aug. 3, 2020
(86) PCT No.: PCT/US2020/044719

§ 371 Date: Jan. 6, 2022

Related U.S. Application Data
(60) Provisional application No. 62/886,523, filed on Aug. 14, 2019.

(51) Int. Cl. A61H 3/00

(52) U.S. Cl. CPC A61H 3/00; A61H 2003/007; A61H 2205/106; A61H 2201/1673; A61H 2201/1463; A61H 2201/1215; A61H 2201/165

(57) ABSTRACT

An enhanced actuator assembly, such as for use in driving a joint member of a wearable robotic device, is characterized by electrical isolation of the motor from the transmission system output. An actuator assembly includes a motor and a transmission system that provides a speed reduction of a motor speed to an output speed. The transmission system includes a non-conductive material layer that electrically isolates the motor from an output of the transmission system. The transmission system may be a two-stage transmission system. A first stage of speed reduction of the transmission system may include a first rotating member, such as a first helical gear, attached to the output shaft of the motor that transmits power to a second rotating member, such as a second helical gear. The second rotating member has a diameter larger than a diameter of the first rotating member to form the first stage of speed reduction, and the non-conductive material layer is part of the second rotating member.

### RELATED APPLICATIONS

This application claims the benefit of U.S. Provisional Application No. 62/886,523 filed Aug. 14, 2019, the contents of which are incorporated herein by reference.

### FIELD OF INVENTION

The present invention relates to powered mobility assistance devices, such as powered orthotic devices, “exoskeleton” devices, and other wearable robotic devices, and more particularly to drive mechanisms for driving the joint components of such devices.

### BACKGROUND OF THE INVENTION

Many health conditions result in significant impairment to mobility, which may be short of complete paralysis or complete paralysis. The large population of persons afflicted with such conditions include, for example, those affected by stroke, multiple sclerosis, ALS, Parkinson's disease, spinal cord injury, cerebral palsy, and many other conditions resulting from birth defects, disease, injury, or aging. Immobility can lead to secondary health problems, such as for example circulatory problems, sores, breathing problems, and deterioration of heart function. To aid mobility, movement assist devices, such as leg orthotic devices, have been employed.

In an effort to restore at least some degree of legged mobility to individuals with paraplegia or significantly impaired mobility, the use of powered orthoses has been under development, which incorporate actuators and drive motors associated with a power supply to assist with locomotion. These powered orthoses have been shown to increase gait speed and decrease compensatory motions, relative to walking without powered assistance. The use of powered orthoses presents an opportunity for electronic control of the orthoses, for enhanced user mobility. One example of a powered mobility assistance device or wearable robotic device is commonly referred to as an “exoskeleton device”. Exoskeleton devices typically include bilateral powered leg braces attached to a torso support, including both knee and hip joints. An example of the current state of the art of exoskeleton devices is shown in Applicant's International Application Serial No. PCT/US2015/23624, entitled “Wearable Robotic Device,” filed Mar. 31, 2015. Other examples of powered mobility assistance devices include powered leg braces. These include powered orthotic devices with leg braces that extend over the knees and incorporate an ankle-foot orthoses to provide support at the ankles, which are coupled with the leg braces to lock the knee joints in full extension (referred to in the art as “knee-ankle-foot-orthoses” or “KAFOs”). In another configuration, the leg brace further may be connected to a hip component that provides added support at the torso (referred to in the art as “hip-knee-ankle-foot-orthoses” or “HKAFOs”).

There is a general concern with powered mobility assistance devices, such as powered orthotic devices or exoskeleton devices, that they be compact and light weight. Device users typically have significant physical impairments, and reducing the size and weight of wearable robotic devices makes them easier to don and otherwise manipulate. With increased ease, users can experience more freedom of mobility, and can reduce the need for outside caregivers and assistance. The drive mechanism for the joint components is one aspect of powered mobility assistance devices that is a continuing subject of concern for rendering wearable robotic devices more compact and light weight. Reduced size and weight must be balanced with performance so as to provide a device that is more user friendly to don and manipulate, while still providing adequate torque and driving forces for operation of the device to an extent requisite with the level of impairment.

Human walking is characterized by relatively slow hip and knee joint rotational motion and relatively high joint torque. To aid—partially or fully—human walking, a variety of hydraulic, pneumatic, and electromechanical orthoses have been developed by universities and companies over the past few decades. Competing interests include maximizing torque output and controllability while minimizing weight, size, noise, and cost. Recent advancements in brushless motor technology and lithium batteries have made electromechanical actuation systems the dominant option for optimizing these tradeoffs. However, electric motors generally experience peak efficiency at relatively high rates of rotation and low torque output. This then requires a transmission system designed to reduce the speed and amplify the torque to bring the performance into a useful range for biomechanical assistance during walking. In the process of adding a transmission to provide outputs conducive to walking, high gearing ratios have often been used, having an approximate transmission ratio of between 500:1 and 1000:1. This high ratio prevents the joints from moving freely when not under power, eliminating back-drivability. This back-drivability is important for individuals who may have some function and be able to participate in the walking motion cooperatively with the mobility assistance device, as user effort to aid walking in combination with the powered assistance can have health benefits for the user and results in a smoother and more efficient gait and recovery.

Another significant concern is user safety in view of the use of powered electrical components. Due to relevant safety standards for medical electrical equipment, there is a requirement that the motor be electrically isolated from the output stage of the transmission to prevent electrical exposure to the user.

### SUMMARY OF THE INVENTION

The present invention is directed to mobility assistance devices such as powered limb or gait orthoses or wearable robotic legged mobility devices or exoskeleton devices, and more particularly to drive mechanisms for driving the joint components of such devices. The present invention further provides an actuator assembly for joint components for other powered orthotic devices, and KAFO and HKAFO devices in particular, that can be readily integrated with standard orthotic bracing that can be customized to user body type. The actuator assembly of the present disclosure provides a smaller and lighter solution for powering wearable orthotic systems, which should also require less torque that is more suitable for compact orthotic devices.

An aspect of the invention is an enhanced actuator assembly that acts as a driving mechanism for joint components in a powered mobility assistance device of the various types referenced above. In exemplary embodiments, an actuator assembly for a powered mobility assistance device is configurated as a high torque, low profile actuator with a flat electric motor and a two-stage speed reduction drive transmission. In exemplary embodiments, the actuator assembly may be configured as a two-stage helical gear/chain drive transmission, including an over-molded gear stage for electrical isolation, noise reduction, and vibration dampening, and magnetic coupling to a driven member.

In exemplary embodiments of a two-stage speed reduction drive transmission, the first stage includes a small diameter helical first gear attached to an output shaft of a flat profile brushless motor, which transmits power to a larger helical second gear to provide a first stage of speed reduction. The large helical second gear is attached to the same shaft as a small diameter first sprocket, which is the first member of the second transmission stage. This small diameter sprocket transmits power to a second sprocket of larger diameter through a roller chain to provide a second stage of speed reduction. With such configuration, the actuator assembly has a thin profile and is extremely lightweight relative to its output torque capability. Each stage of the transmission is highly efficient and thus very little power is lost through the transmission. Importantly, the transmission is also back-drivable, meaning that a torque applied at the output will cause the transmission, and ultimately the motor, to spin. This back-drivability is significant to enable cooperative motion when a wearable robotic device is worn by a user who is able to contribute some power via their own muscles.

Due to relevant safety standards for medical electrical equipment, there is a requirement that the motor be electrically isolated from the output stage of the transmission to prevent electrical exposure to the user. This is accomplished by configuring the large helical second gear as a separate inner ring and outer ring, with a non-conductive plastic layer between the rings that may be formed using a suitable molding process. Internal ridges on the rings provide for enhanced mechanical holding of the plastic layer to accommodate radial and thrust loads. An added advantage of such a configuration is that noise dampening also occurs because the most significant source of audible noise emanates from the high speed small helical first gear teeth impacting the teeth on the larger helical second gear. As the large helical gear outer ring is mounted to a damping medium in the embodiments of the present disclosure, the vibration of each impact is significantly absorbed rather than transmitted. In an exemplary embodiment, the larger helical second gear outer and inner rings are isolated by an over-molded non-conductive inner material layer, which may be made of any suitable plastic material.

An aspect of the invention is an enhanced actuator assembly, such as for use in driving a joint member of a wearable robotic device, that is characterized by electrical isolation of the motor from the transmission system output. In exemplary embodiments, an actuator assembly includes a motor and a transmission system that provides a speed reduction of a motor speed to an output speed. The transmission system includes a non-conductive material layer that electrically isolates the motor from an output of the transmission system. The transmission system may be a two-stage transmission system. A first stage of speed reduction of the transmission system may include a first rotating member, such as a first helical gear, attached to the output shaft of the motor that transmits power to a second rotating member, such as a second helical gear. The second rotating member has a diameter larger than a diameter of the first rotating member to form the first stage of speed reduction, and the non-conductive material layer may be part of the second rotating member.

The second rotating member may include an inner ring and an outer ring made of an electrically conductive material, and the non-conductive material layer is located between the inner ring and the outer ring. The inner ring may include a first set of internal ridges that extends radially outward onto which the non-conductive material layer is disposed, and the outer ring may include a second set of internal ridges that extends radially inward onto which the non-conductive material layer is disposed. In additional to electrical isolation, the ridged configuration further may provide noise reduction and vibration dampening.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting an isometric view of an exemplary actuator assembly for use with a wearable robotic device, in accordance with embodiments of the present application.

FIG. 2 is a drawing depicting an isometric view of the exemplary actuator assembly of FIG. 1, with a portion of the actuator housing removed.

FIG. 3 is a drawing depicting an isometric top-oriented view of the drive components of the actuator assembly of FIG. 1 in isolation.

FIG. 4 is a drawing depicting an isometric bottom-oriented view of the drive components of the actuator assembly of FIG. 1 in isolation.

FIG. 5 is a drawing depicting a top view of the drive components of the actuator assembly of FIG. 1 in isolation.

FIG. 6 is a drawing depicting a side view of the drive components of the actuator assembly of FIG. 1 in isolation.

FIG. 7 is a drawing depicting a bottom view of the drive components of the actuator assembly of FIG. 1 in isolation.

FIG. 8 is a drawing depicting an isometric view of an exemplary over-molded gear component for use in the actuator assembly.

FIG. 9 is a drawing depicting an exemplary knee-ankle-foot orthotic (KAFO) device, which incorporates an actuator assembly in accordance with embodiments of the present application.

FIG. 10 is a drawing depicting an exemplary hip-knee-ankle-foot orthotic (HKAFO) device, which incorporates a first actuator assembly and a second actuator assembly in accordance with embodiments of the present application.

### DETAILED DESCRIPTION

Embodiments of the present invention will now be described with reference to the drawings, wherein like reference numerals are used to refer to like elements throughout. It will be understood that the figures are not necessarily to scale.

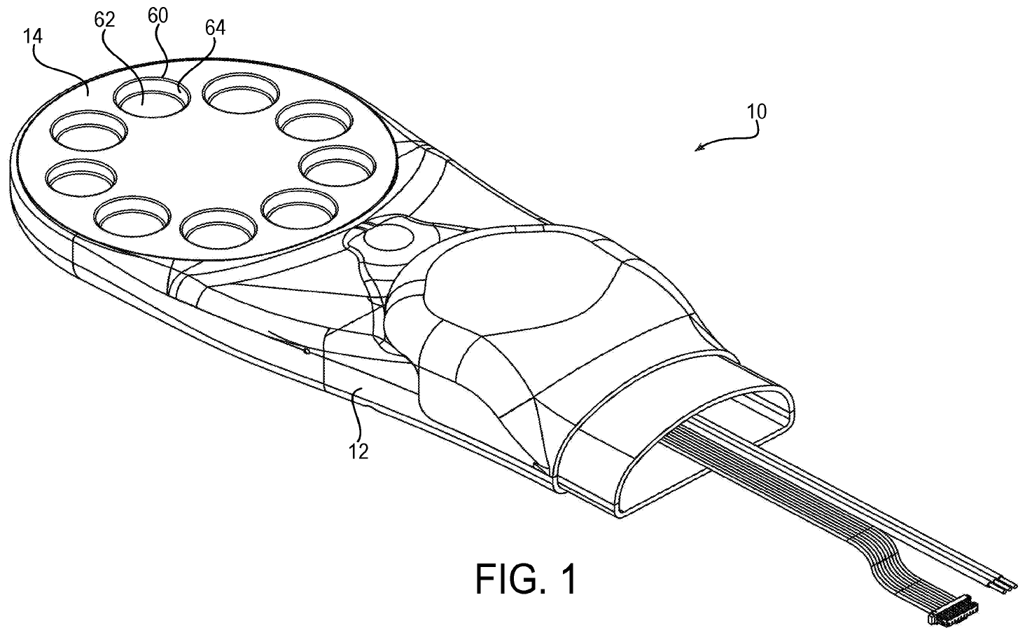

FIG. 1 is a drawing depicting an isometric view of an exemplary actuator assembly 10 for use with a wearable robotic device, in accordance with embodiments of the present application. The actuator assembly 10 includes an actuator housing 12 that encloses components of a speed reduction drive transmission, which is described in more detail below. The actuator assembly 10 further includes an output wheel 14 that may be coupled to a mating link component of a driven joint member (not shown) for driving a joint component of a wearable robotic device. The actuator assembly 10 further includes various electrical and signal connections 16 through which power and control signals may be provided to control operation of the actuator assembly.

An aspect of the invention, therefore, is an enhanced actuator assembly, such as for use in driving a joint member of a wearable robotic device, that is characterized by electrical isolation of the motor from the transmission system output. In exemplary embodiments, an actuator assembly includes a motor and a transmission system that provides a speed reduction of a motor speed to an output speed. The transmission system includes a non-conductive material layer that electrically isolates the motor from an output of the transmission system. The transmission system may be a two-stage transmission system. A first stage of speed reduction of the transmission system may include a first rotating member attached to the output shaft of the motor that transmits power to a second rotating member. The second rotating member has a diameter larger than a diameter of the first rotating member to form the first stage of speed reduction, and the non-conductive material layer may be part of the second rotating member.

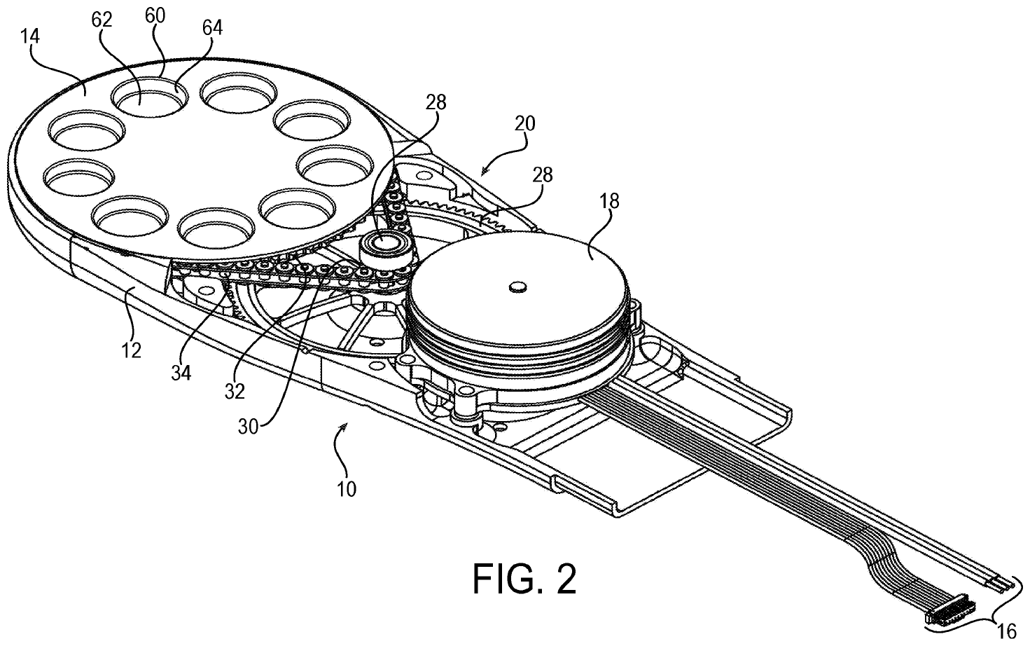

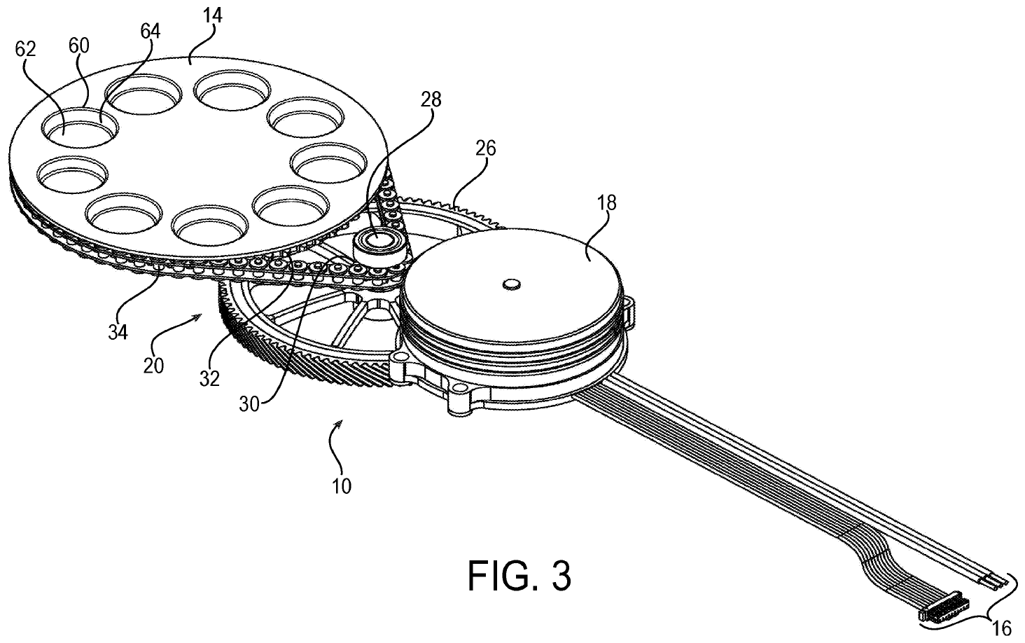

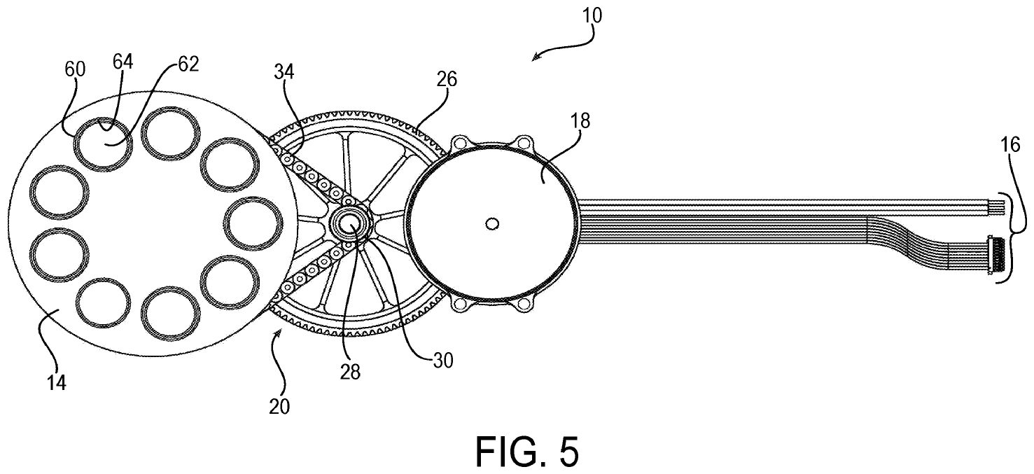

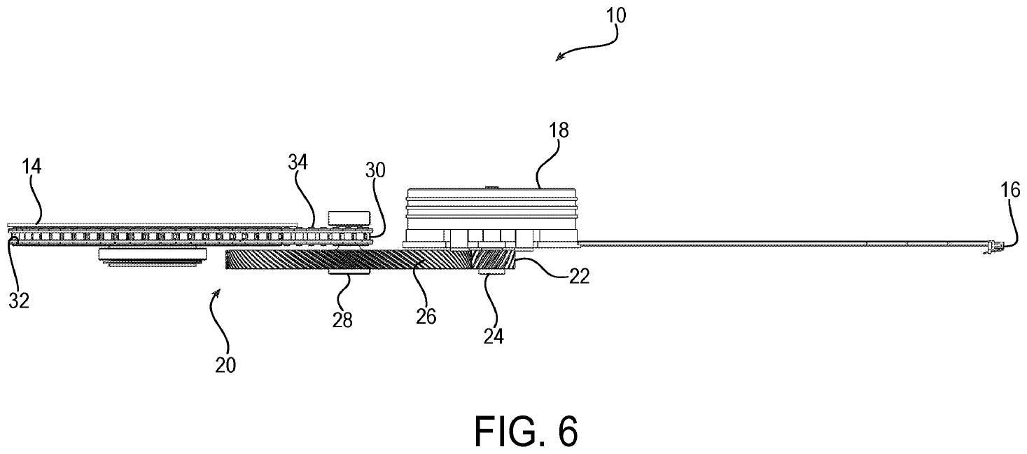

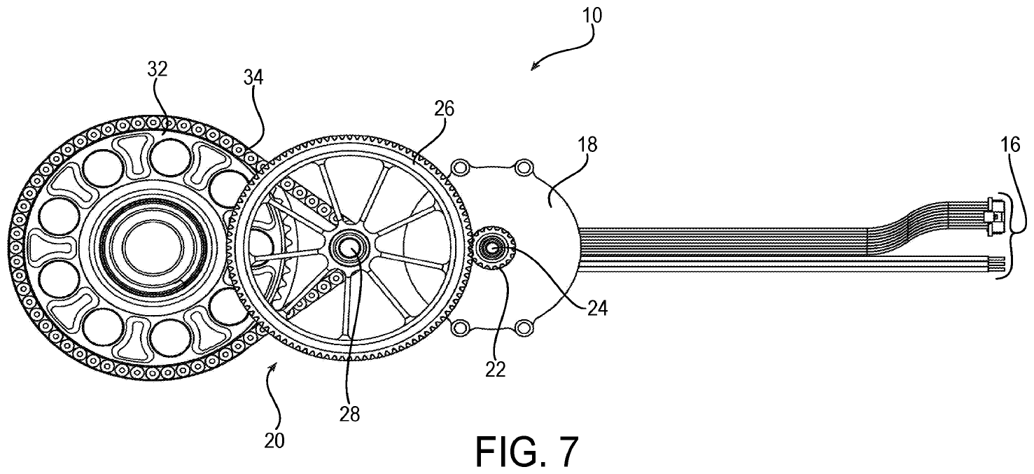

FIGS. 2-7 are drawings depicting various views of the actuator assembly 10 with the actuator housing partially or wholly removed so as to depict the drive components of the actuator assembly in isolation. Generally, the actuator assembly components include a motor 18 and a transmission system 20 that has an output corresponding to the driving of the output wheel 14, which as referenced above can operate to drive a joint member of a wearable robotic device. As described in more detail below, in exemplary embodiments the actuator assembly 10 is configured as a high torque, low profile actuator with the motor 18 configured as a flat electric motor, and the transmission system 20 being configured as a two-stage speed reduction drive transmission. The motor 18 may be a brushless DC motor.

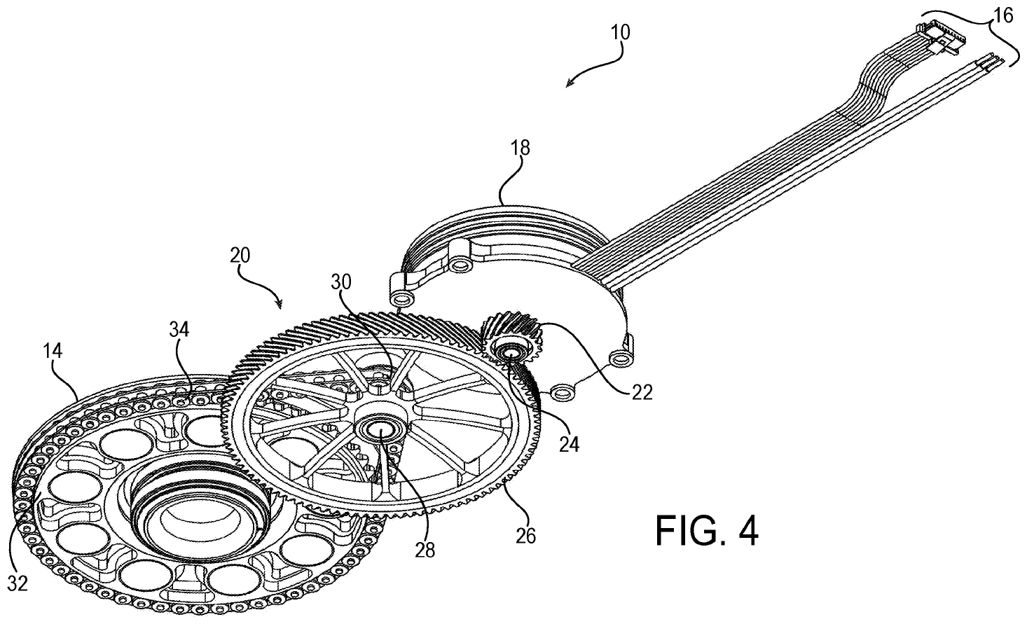

Referring to FIGS. 2-7, as referenced above in exemplary embodiments the transmission system 20 is a two-stage transmission system. A first stage of speed reduction of the transmission system 20 includes a relatively small diameter first rotating member 22, such as a first gear, that is attached to an output shaft 24 of the flat profile brushless motor 18. The small diameter first gear 22 transmits power to a relatively large second rotating member 26, such as a second gear, via interaction of the gear teeth of the first and second gears, to form the first stage of speed reduction. In other words, for appropriate speed reduction a diameter of the second gear 26 is larger than a diameter of the first gear 22. The first and second gears may be helical gears, i.e., the gear teeth may have a spiraled or inclined orientation relative to the rotational axes of the gears. The interaction of the first and second gears is best seen in the more bottom oriented views of FIGS. 4 and 6-7.

For a second stage of speed reduction, as referenced above the relatively large diameter second gear 26 is the output of the first stage of speed reduction, and the second gear 26 is attached to a shaft 28. The shaft 28 is commonly attached to a third rotating member 30, such as for example a relatively small diameter first sprocket. The small diameter first sprocket 30 transmits power to a relatively large fourth rotating member 32, such as for example a second sprocket, via a transmission member 34 to form the second stage of speed reduction. In other words, for appropriate speed reduction a diameter of the second sprocket 32 is larger than a diameter of the first sprocket 30. In this embodiment, the transmission member 26 is configured as a chain that engages around the first and second sprockets. The output wheel 14 is fixed to the second sprocket 32 to provide an output of the second stage, and thus an output of the transmission system and of the overall actuator assembly.

As an alternative configuration of the second stage of the transmission system 20, the second stage may be configured as a belt/pulley stage instead of a sprocket/chain stage. In such embodiment, the second stage of the transmission system 20 includes the third rotating member configured as a relatively small diameter first pulley that similarly transmits power to the fourth rotating member configured as a relatively large diameter second pulley, and in this embodiment the transmission member is configured as a belt that engages around the two pulleys. The belt may be tensioned by spring loaded idlers located on opposite sides of the first pulley. Similarly as in the previous embodiment, for appropriate speed reduction a diameter of the second pulley is larger than a diameter of the first pulley.

The actuator assembly also is back-drivable, meaning that a torque applied at the output of a driven joint component will cause the transmission system, and ultimately the motor, to spin. This back-drivability is significant as it enables cooperative motion with a wearable robotic device worn by a user who is able to contribute some power for walking via their own muscles. By permitting user contribution to the walking power, the user experiences health benefits of muscle strengthening and ultimately an enhanced gait, characterized by a smoother gait motion and higher efficiency. In exemplary embodiments suitable for use with a wide variety of wearable robotic devices, the actuator assembly has a total transmission ratio of approximately 44.4:1, and a maximum continuous torque of approximately 7 Nm. With a weight of approximately 20 oz, the continuous torque-to-weight ratio of the actuator assembly of this configuration is approximately 0.35 Nm/oz.

The components of the actuator assembly principally are made of any suitable metal materials as are commonly used in the art, which may be electrically conductive. As referenced above, due to relevant safety standards for medical electrical equipment, there is a requirement that the motor be electrically isolated from the output stage of the transmission system to prevent electrical exposure to the user. In embodiments of the present disclosure, electrical isolation of the transmission output from the motor is accomplished by incorporating a non-conductive material layer into the transmission system to electrically isolate the transmission output from the motor. The non-conductive material layer may be incorporated into one of the rotating members of the transmission system. In an exemplary configuration, the non-conductive material layer is provided by configuring the large second gear 26 of the first transmission stage as a separate inner ring and outer ring, with a non-conductive material layer being located between the rings. The non-conductive material layer may be formed of plastic and incorporated into the second gear 26 using a suitable molding process. In an exemplary embodiment, the larger helical second gear outer and inner rings are isolated by an over-molded non-conductive material layer, which may be made of any suitable plastic material.

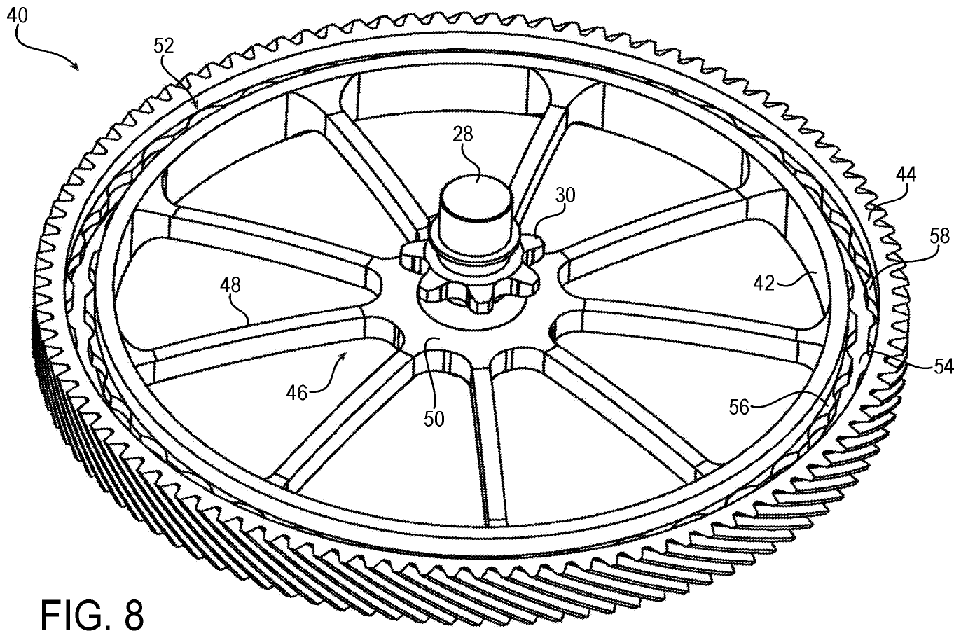

Accordingly, FIG. 8 is a drawing depicting an isometric view of an exemplary over-molded gear component 40 for use in the actuator assembly, in accordance with embodiments of the present application. The gear component 40 is illustrated as attached to the shaft 28 in combination with the first sprocket 30 that is part of the second stage of speed reduction that are illustrated in previous figures. The gear component 40 includes an inner ring 42 and an outer ring 44. The ringed structure is supported by a frame 46 that may include spokes 48 that extend from a central hub 50 to reduce the material and thus the weight of the gear component. The inner ring 42 and outer ring 44 are spaced apart from each other by a non-conductive material layer 52. The non-conductive material layer 52 may be any suitable plastic material. Suitable materials include (without limitation) thermoplastics like nylon, acrylonitrile butadiene styrene (ABS), or polycarbonate, or urethane elastomers. The non-conductive material layer 52 may be formed using a molding process whereby the non-conductive material layer 52 is over-molded onto the ringed structure including the inner ring 42 and outer ring 44. In this manner, the inner ring and the outer ring are electrically isolated from each other by the incorporation of the non-conductive material layer between the inner and outer rings. By separating the metal inner and outer rings from each other with the non-conductive material layer 52, electrical isolation is achieved whereby the motor is electrically isolated from the output of the transmission system by the intervening non-conductive material layer 52.

The ringed structure of the gear component 40 onto which non-conductive material layer 52 is provided may include a base layer 54 and a plurality of internal ridges that extend from the inner and outer rings. In an exemplary embodiment as shown in FIG. 8, the inner ring 42 may include a first set of internal ridges 56 that extends radially outward onto which the non-conductive material layer 52 is disposed, and the outer ring 44 may include a second set of internal ridges 58 that extends radially inward onto which the non-conductive material layer 52 is disposed. The first and second sets of internal ridges may be interspersed relative to each other so as to form cooperating opposing teeth. The internal ridges on the inner and outer rings provide for enhanced mechanical holding of the non-conductive (plastic) material layer 52 to accommodate radial and thrust loads. An added advantage of such a configuration is that noise dampening also occurs because the most significant source of audible noise emanates from the high speed small helical first gear teeth impacting the teeth on the larger helical second gear. In addition, as the large helical gear outer ring is mounted to a damping medium constituting the non-conductive material layer 52, the vibration of each impact also is significantly absorbed rather than transmitted. Accordingly, the configuration of the gear component 40 with the non-conductive material layer 52 achieves the combined advantages of electrical isolation of the transmission output from the motor, noise reduction, and vibration dampening.

In application, the actuator assembly is attached to one limb component of a wearable robotic device, such as a thigh component, and a mating link would be attached to an adjacent limb component of a wearable robotic device, such as the lower leg component. In one embodiment of the actuator assembly, the mating link may be attached to the output wheel of the actuator assembly by means of a magnetic coupling. Referring back to FIGS. 1-7, the output wheel 14 may be configured as a magnetic coupling component that employs magnetic force to couple to a mating link, which for example may be part of a driven joint member of a wearable robotic device. An example of such a magnetic coupling system is described in Applicant's application Ser. No. 16/338,886 filed on Apr. 2, 2019 (which is a national stage of PCT/US2018/013992 filed Jan. 17, 2018), the contents of which are incorporated here by reference.

In accordance with a magnetic coupling configuration, the output wheel 14 may include a plurality of recessed pockets 60 that can provide for magnetic coupling of the actuator assembly 10 to a mating link (not shown) of a driven component that is driven by rotation of the output wheel 14. In the depicted example, the output wheel 14 includes nine such recessed pockets 60 spaced equidistantly around the output wheel as an exemplary embodiment, although any suitable number of recessed pockets may be employed. One or more of the recessed pockets 60 includes a magnetic element 62 located at the bottom of the recessed pocket (i.e., there are up to nine magnetic elements in this embodiment) that are used for magnetic coupling, and cooperating magnetic elements may be included on the driven component additionally or alternatively to the magnetic elements of the actuator assembly. In this regard, all of the recessed pockets, or less than all of the recessed pockets, may include a magnetic element 62. In exemplary embodiments, the magnetic elements 62 each may be configured as an actual magnet, such as a cylindrical neodymium disc magnet, installed in the bottom of the recessed pocket 60. Instead of actual magnets, each of the magnetic elements 62 alternatively may be configured as a ferrous material that is magnetically attracted to a magnet located on the cooperating mating link of a driven component. Each recessed pocket further may include an inclined or stepped mating surface 64 extending from an outer surface the output wheel 14 toward a bottom of the recessed pocket 60, which aids in magnetic coupling to a cooperating mating surface of the driven component.

In exemplary embodiments, magnetic elements on a cooperative mating link similarly may be configured as a neodymium disc magnet installed in an end of a cooperating mating feature, with a polarity opposite to that of a respective magnetic element 62 on the actuator assembly 10 to provide magnetic coupling of the two components. Once magnetically coupled, opposing mating surfaces provide a mechanical interface for torque accommodation. To further enhance the self-aligning capability of the magnetic coupling system, the magnetic elements may be positioned to provide a magnetic keying system for proper alignment of the actuator assembly and a driven component. The magnetic keying may be achieved by the magnetic elements in each of the output wheel 14 and the driven component being installed with alternating and opposite polarity. In this way, the magnetic coupling system has magnetic keying that actively forces the two components apart if the user is attempting to make the coupling in the wrong orientation or with an incorrect alignment of the recessed pockets 60 and cooperating structures on a mating link of a driven component. Additional details of an exemplary magnetic coupling system are set forth in Applicant's '886 application referenced above.

The actuator assembly 10 including an electrical isolating rotating member (gear component) 40 may be incorporated into essentially any suitable wearable robotic device, such as for example in an exoskeleton device or a powered orthotic device. For example, the actuator assembly may be incorporated into a conventional KAFO device or an HKAFO device.

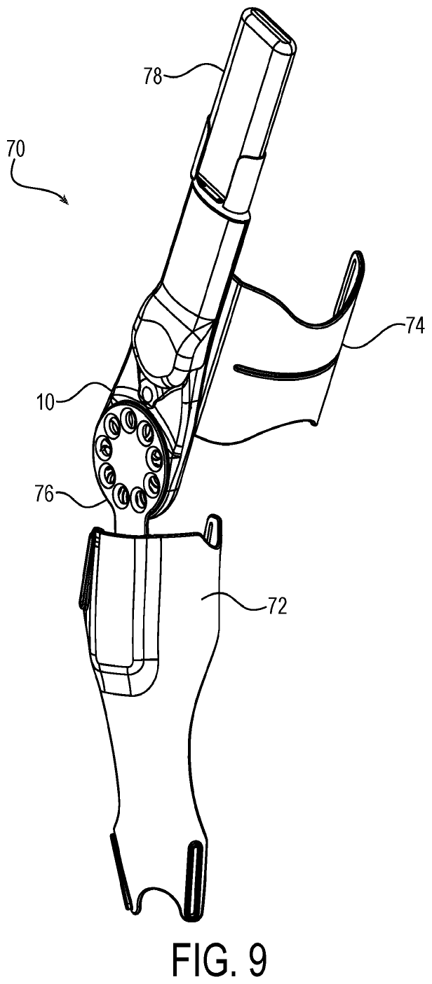

FIG. 9 is a drawing depicting an exemplary knee-ankle-foot orthotic (KAFO) 70 device, which incorporates an actuator assembly 10 in accordance with embodiments of the present application. The KAFO device includes a leg brace that includes a calf support 72 and a thigh support 74 that wrap around a user's leg. Such components may be secured to the user using straps that are retained with any suitable mechanical fasteners, such as Velcro®. The leg brace connects the components to each other by arranging the components on a frame, typically made of metal such as for example steel, stainless steel, or aluminum. The referenced components form an orthotic brace to provide support for a user during walking. As is typical, a KAFO device may include an ankle-foot orthosis (not shown) including a foot plate and an ankle support that can receive the foot of the user (typically including a shoe). The foot plate may operate with a pressure sensor that can detect when the foot plate is on or off of the ground to aid in the gait control. The pressure sensor may be incorporated as part of the foot plate or provided as a separate component that comes in contact with the foot plate, for pressure sensing. The pressure sensor may be wired or wirelessly connected to the control electronics of the actuator assembly.

Generally, the output wheel of the actuator assembly 10 is connected to a driven joint member 76, whereby operation of the driven joint member rotates to operate a joint of the orthotic device. In the example of a KAFO device, the actuator assembly 10 operates as a powered knee joint. The actuator assembly is mounted to the thigh support of the KAFO device. In operation, the actuator assembly drives the driven joint member 76 as described above to provide extension and flexion of the user's knee joint. As shown in this example, the KAFO device further may include a battery back 78 that supplies power to the actuator assembly 10. The battery back may be a removable battery back that supplies power and control signals through the connections 16 shown in FIG. 1-7.

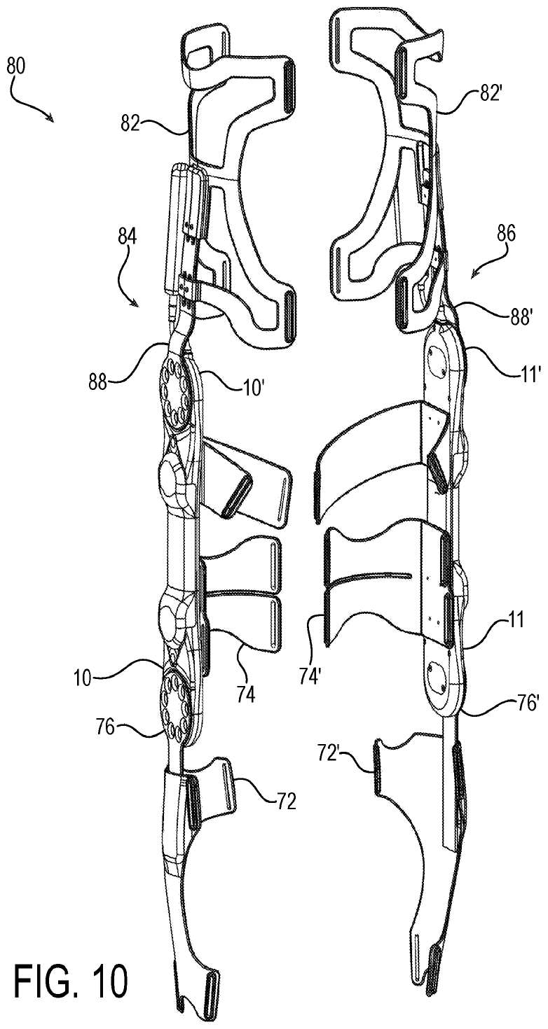

FIG. 10 is a drawing depicting an exemplary hip-knee-ankle-foot orthotic (HKAFO) device 80, which incorporates a first actuator assembly 10 and a second actuator assembly 10′ in accordance with embodiments of the present application. Similarly as above, the actuator assemblies may be incorporated into essentially any conventional HKAFO device. As is typical, the HKAFO device generally includes the components of the KAFO device described above. The HKAFO device further includes a torso support 82 that wraps around a user's torso. The torso support also may be secured to the user using straps that are retained with any suitable mechanical fasteners, such as Velcro®. The referenced components form an orthotic brace with added torso support to provide support for a user during walking. The HKAFO device may be a unilateral support device including brace components only for one leg, or a bilateral HKAFO device may be provided in which comparable brace components are provided for both legs (reference numerals given a prime—′— indication for comparable components). The example of FIG. 10 is a bilateral device, in which actuator assemblies 10 and 10′ are provided on a right side component 84, and additional actuator assemblies 11 and 11′ are provided on a left side component 86.

In the example of an HKAFO device, first actuator assemblies 10 and/or 11 are positioned and operate as a powered knee joint in the manner described above for the KAFO device. In addition, second actuator assemblies 10′ and/or 11′ are positioned and operate as a powered hip joint. The second actuator assemblies are mounted to the torso support and drive a hip joint component 88 (and 88′ for bilateral) of the HKAFO device. In operation, the first and second actuator assemblies respectively drive both the driven joint members to provide extension and flexion of the user's knee and hip joints. In addition, although an example HKAFO device may include both powered knee and hip joints, one or the other of powered hip versus knee joints may be employed with the HKAFO brace configuration.

An aspect of the invention, therefore, is an enhanced actuator assembly, such as for use in driving a joint member of a wearable robotic device, that is characterized by electrical isolation of the motor from the transmission system output. In exemplary embodiments, the actuator assembly includes a motor and a transmission system that provides a speed reduction of a motor speed to an output speed. The transmission system includes a non-conductive material layer that electrically isolates the motor from an output of the transmission system. The actuator assembly may include one or more of the following features, either individually or in combination.

In an exemplary embodiment of the actuator assembly, the transmission system comprises a first stage of speed reduction connected to an output shaft of the motor for providing a speed reduction of the motor output; and a second stage of speed reduction linked to an output of the first stage of speed reduction for providing a speed reduction from the output of the first stage to the output speed. The non-conductive material layer is part of one of the first stage of speed reduction or the second stage of speed reduction.

In an exemplary embodiment of the actuator assembly, the first stage of speed reduction comprises a first rotating member attached to the output shaft of the motor that transmits power to a second rotating member; the second rotating member has a diameter larger than a diameter of the first rotating member to form the first stage of speed reduction; and the non-conductive material layer is part of the second rotating member.

In an exemplary embodiment of the actuator assembly, the second rotating member comprises an inner ring and an outer ring made of an electrically conductive material, and the non-conductive material layer is located between the inner ring and the outer ring.

In an exemplary embodiment of the actuator assembly, the inner ring includes a first set of internal ridges that extends radially outward onto which the non-conductive material layer is disposed, and the outer ring includes a second set of internal ridges that extends radially inward onto which the non-conductive material layer is disposed.

In an exemplary embodiment of the actuator assembly, the first and second sets of internal ridges are interspersed relative to each other so as to form cooperating opposing teeth.

In an exemplary embodiment of the actuator assembly, the non-conductive material layer is over-molded onto the inner and outer rings.

In an exemplary embodiment of the actuator assembly, the first and second rotating members are gear components.

In an exemplary embodiment of the actuator assembly, the first and second rotating members are helical gears.

In an exemplary embodiment of the actuator assembly, the non-conductive material layer is made of plastic.

In an exemplary embodiment of the actuator assembly, the second stage of speed reduction comprises a shaft that is commonly attached to the second rotating member and a third rotating member that transmits power to a fourth rotating member by a transmission member; the fourth rotating member has a diameter larger than a diameter of the third rotating member to provide the second stage of speed reduction; and an output wheel is fixed to the fourth rotating member to provide the output of the transmission system.

In an exemplary embodiment of the actuator assembly, the third and fourth rotating members are sprockets, and the transmission member is a roller chain that interacts with the teeth of the sprockets as the sprockets rotate.

In an exemplary embodiment of the actuator assembly, the output wheel includes a magnetic coupling comprising a plurality of magnetic elements that are configured to magnetically couple with an opposing magnetic coupling of a driven component.

In an exemplary embodiment of the actuator assembly, the magnetic coupling comprises a plurality of recessed pockets, and at least one of the recessed pockets includes a respective one of the plurality of magnetic elements located at a bottom of the recessed pocket.

In an exemplary embodiment of the actuator assembly, each recessed pocket includes a mating surface extending from an outer surface the output wheel toward a bottom of the recessed pocket.

In an exemplary embodiment of the actuator assembly, the mating surface is a tapered mating surface.

In an exemplary embodiment of the actuator assembly, each recessed pocket includes a respective one of the plurality of magnetic elements.

In an exemplary embodiment of the actuator assembly, the magnetic elements are neodymium disc magnets.

Another aspect of the invention is orthotic device that includes a knee-ankle-foot orthosis (KAFO) brace; an actuator assembly according to any of the embodiments, and a driven joint member; wherein the actuator assembly is attached to a thigh support of the KAFO brace, and the driven joint member acts a knee joint of the KAFO brace.

Another aspect of the invention is an orthotic device that includes a hip-knee-ankle-foot orthosis (HKAFO) brace; a first actuator assembly according to any of the embodiments and a first driven joint member; wherein the first actuator assembly is attached to a thigh support of the HKAFO brace, and the first driven joint member acts a knee joint of the HKAFO brace; and/or a second actuator assembly according to any of the embodiments and a second driven joint member; wherein the second actuator assembly is attached to a torso support of the HKAFO brace, and the second driven joint member acts a hip joint of the HKAFO brace.

Another aspect of the invention is a related rotating member that includes a non-conductive material layer to achieve electrical isolation across the rotating member. In exemplary embodiments the rotating member includes an inner ring and an outer ring made of an electrically conductive material; and a non-conductive material layer that is located between the inner ring and the outer ring, wherein the non-conductive material layer electrically isolates the inner ring from the outer ring. The rotating member may include one or more of the following features, either individually or in combination.

In an exemplary embodiment of the rotating member, the inner ring includes a first set of internal ridges that extends radially outward onto which the non-conductive material layer is disposed, and the outer ring includes a second set of internal ridges that extends radially inward onto which the non-conductive material layer is disposed.

In an exemplary embodiment of the rotating member, the first and second sets of internal ridges are interspersed relative to each other so as to form cooperating opposing teeth.

In an exemplary embodiment of the rotating member, the non-conductive material layer is over-molded onto the inner and outer rings.

In an exemplary embodiment of the rotating member, the rotating member further includes gear teeth located on an outer diameter of the rotating member.

In an exemplary embodiment of the rotating member, the rotating member is a helical gear.

In an exemplary embodiment of the rotating member, the non-conductive material layer is made of plastic.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An actuator assembly comprising:
a motor; and
a transmission system that provides a speed reduction of a motor speed to an output speed;
wherein:
the transmission system includes a non-conductive material layer that electrically isolates the motor from an output of the transmission system;
the transmission system comprises a first stage of speed reduction connected to an output shaft of the motor for providing a speed reduction of the motor output, and a second stage of speed reduction linked to an output of the first stage of speed reduction for providing a speed reduction from the output of the first stage to the output speed, the first stage of speed reduction comprising a first rotating member attached to the output shaft of the motor that transmits power to a second rotating member;
the second rotating member comprises an inner ring and an outer ring made of an electrically conductive material and the non-conductive material layer is located between the inner ring and the outer ring; and
the inner ring includes a first set of internal ridges that extends radially outward onto which the non-conductive material layer is disposed, and the outer ring includes a second set of internal ridges that extends radially inward onto which the non-conductive material layer is disposed.

2. The actuator assembly of claim 1, wherein the first and second sets of internal ridges are interspersed relative to each other so as to form cooperating opposing teeth.

3. The actuator assembly of claim 1, wherein the non-conductive material layer is over-molded onto the inner and outer rings.

4-5. (canceled)

6. The actuator assembly of claim 1, wherein the non-conductive material layer is made of plastic.

7. The actuator assembly of claim 1, wherein:
the second stage of speed reduction comprises a shaft that is commonly attached to the second rotating member and a third rotating member that transmits power to a fourth rotating member by a transmission member;
the fourth rotating member has a diameter larger than a diameter of the third rotating member to provide the second stage of speed reduction; and
an output wheel is fixed to the fourth rotating member to provide the output of the transmission system.

8. The actuator assembly of claim 7, wherein third and fourth rotating members are sprockets, and the transmission member is a roller chain that interacts with the teeth of the sprockets as the sprockets rotate.

9. The actuator assembly of any of claim 7, wherein the output wheel includes a magnetic coupling comprising a plurality of magnetic elements that are configured to magnetically couple with an opposing magnetic coupling of a driven component.

10. The actuator assembly of claim 9, wherein the magnetic coupling comprises a plurality of recessed pockets, and at least one of the recessed pockets includes a respective one of the plurality of magnetic elements located at a bottom of the recessed pocket.

11. The actuator assembly of claim 9, wherein each recessed pocket includes a mating surface extending from an outer surface the output wheel toward a bottom of the recessed pocket.

12. The actuator assembly of claim 11, wherein the mating surface is a tapered mating surface.

13. The actuator assembly of claim 10, wherein each recessed pocket includes a respective one of the plurality of magnetic elements.

14. (canceled)

15. An orthotic device comprising:
a knee-ankle-foot orthosis (KAFO) brace; and
an actuator assembly according to claim 1 and a driven joint member;
wherein the actuator assembly is attached to a thigh support of the KAFO brace, and the driven joint member acts a knee joint of the KAFO brace.

16. An orthotic device comprising:
a hip-knee-ankle-foot orthosis (HKAFO) brace;
a first actuator assembly according to claim 1 and a first driven joint member;
wherein the first actuator assembly is attached to a thigh support of the HKAFO brace, and the first driven joint member acts a knee joint of the HKAFO brace; and/or
a second actuator assembly according to claim 1 and a second driven joint member;
wherein the second actuator assembly is attached to a torso support of the HKAFO brace, and the second driven joint member acts a hip joint of the HKAFO brace.

17. A rotating member comprising:
an inner ring and an outer ring made of an electrically conductive material; and
a non-conductive material layer that is located between the inner ring and the outer ring, wherein the non-conductive material layer electrically isolates the inner ring from the outer ring.

18. The rotating member of claim 17, wherein the inner ring includes a first set of internal ridges that extends radially outward onto which the non-conductive material layer is disposed, and the outer ring includes a second set of internal ridges that extends radially inward onto which the non-conductive material layer is disposed.

19. The rotating member of claim 18, wherein the first and second sets of internal ridges are interspersed relative to each other so as to form cooperating opposing teeth.

20. The rotating member of claim 17, wherein the non-conductive material layer is over-molded onto the inner and outer rings.

21. The rotating member of claim 17, further comprising gear teeth located on an outer diameter of the rotating member.

22. The rotating member of claim 17, wherein the rotating member is a helical gear.

23. The rotating member of claim 17, wherein the non-conductive material layer is made of plastic.

24-27. (canceled)
